(19) United States
(12) Patent Application Publication
(10) Pub. No.: US 2021/0097579 A1
(43) Pub. Date: Apr. 1, 2021

(54) Advertising System

(71) Applicant: ULSee Inc., Taipei City 104 (TW)

(72) Inventor: Zhou Ye, Taipei City (TW)

(21) Appl. No.: 16/589,318

(22) Filed: Oct. 1, 2019

(51) Int. Cl. G06Q 30/02

(52) U.S. Cl. CPC G06Q 30/0271; G06Q 30/0255

(57) ABSTRACT

An advertising is provided. The advertising system, characterized by comprising: an electronic device including: a lens exposed outside the electronic device; an recognition unit scanning the face of a use or a body of the user through the lens to obtain a user feature information; an online browsing unit including at least one online consumption behavior information; and an offline browsing unit including at least one offline consumption behavior information; and a data management server network connected to the electronic device, the user feature information, the online consumption behavior information, and the offline consumption behavior information being transmitted to the data management server, and the data management server including an analysis unit; wherein the analysis unit generates a user preference information according to the user feature information, the online consumption behavior information, and the offline consumption behavior information.

### FIELD OF THE INVENTION

The present invention relates to an advertising system, in particular, to an advertising system based on face recognition.

### BACKGROUND OF THE INVENTION

Nowadays, shopping malls often set up electronic billboards to broadcast advertising information to consumers. For example, when the consumer approaches a mall door, the electronic billboard immediately plays the advertisement to the consumer. However, uncategorized advertisements are not available for each consumer's shopping preferences and purchase needs. As such, for most consumers, uncategorized advertisements have little appeal, so consumers still don't have the desire to buy and generate an actual consumption behavior.

Therefore, how to provide corresponding advertising information according to different consumer preferences and purchasing needs and how to improve the actual benefits of advertising are worthy of consideration by those skilled in the art.

### SUMMARY OF THE INVENTION

The purpose of the present invention is to provide an advertising system, which may provide corresponding advertising information according to different consumer preferences and purchasing needs and improve the actual benefits of advertising.

According to an exemplary embodiment, an advertising is provided. The advertising system, characterized by comprising: an electronic device including: a lens exposed outside the electronic device; an recognition unit scanning the face of a use or a body of the user through the lens to obtain a user feature information; an online browsing unit including at least one online consumption behavior information; and an offline browsing unit including at least one offline consumption behavior information; and a data management server network connected to the electronic device, the user feature information, the online consumption behavior information, and the offline consumption behavior information being transmitted to the data management server, and the data management server including an analysis unit; wherein the analysis unit generates a user preference information according to the user feature information, the online consumption behavior information, and the offline consumption behavior information.

In one embodiment, the data management server further includes an advertising unit, and the advertising unit generates a multimedia file according to the user preference information.

In one embodiment, the electronic device further includes a display screen, which is exposed outside the electronic device.

In one embodiment, the advertising unit is configured to transmit the multimedia file to the electronic device, and the electronic device plays the multimedia file via the display screen.

In one embodiment, the electronic device is a smart phone, a smart watch, a tablet, a laptop, or an upright advertising machine.

### BRIEF DESCRIPTION OF THE DRAWINGS

Aspects of the present invention are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an advertising system 10 according to an embodiment of the present invention.

FIG. 2 illustrates a view showing that the lens 120 scans a face of a user 8.

FIG. 3 is a view showing that the lens scans the whole body of the user 8.

### DETAILED DESCRIPTION OF PREFERRED EMBODIMENTS

The following invention provides different embodiment, or examples, for implementing different features of the provided subject matter. Specific examples of components and arrangements are described below to simplify the present invention. These are, of course, merely examples and are not intended to be limiting. For example, the formation of a first feature over or on a second feature in the description that follows may include embodiment in which the first and second features are formed in direct contact, and may also include embodiment in which additional features may be formed between the first and second features, such that the first and second features may not be in direct contact. In addition, the present invention may repeat reference numerals and/or letters in the various examples. This repetition is for the purpose of simplicity and clarity and does not in itself dictate a relationship between the various embodiment and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

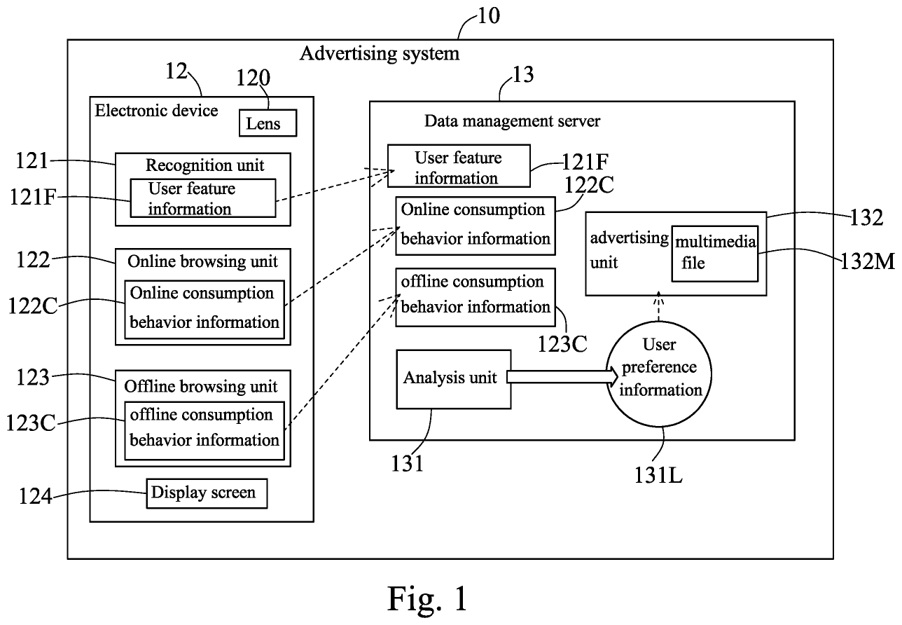

With reference to FIG. 1, FIG. 1 illustrates an advertising system 10 according to an embodiment of the present invention. The advertising system 10 comprises an electronic device 12 and a data management server 13, and the data management server 13 is network connected to the electronic device 12. Among them, the electronic device 12 includes a lens 120, a recognition unit 121, an online browsing unit 122, an offline browsing unit 123 and a display screen 124; the data management server 13 includes an analysis unit 131 and an advertising unit 132. In the above description, for example, the electronic device 12 is a smart phone, a smart watch, a tablet, a laptop, or an upright advertising machine.

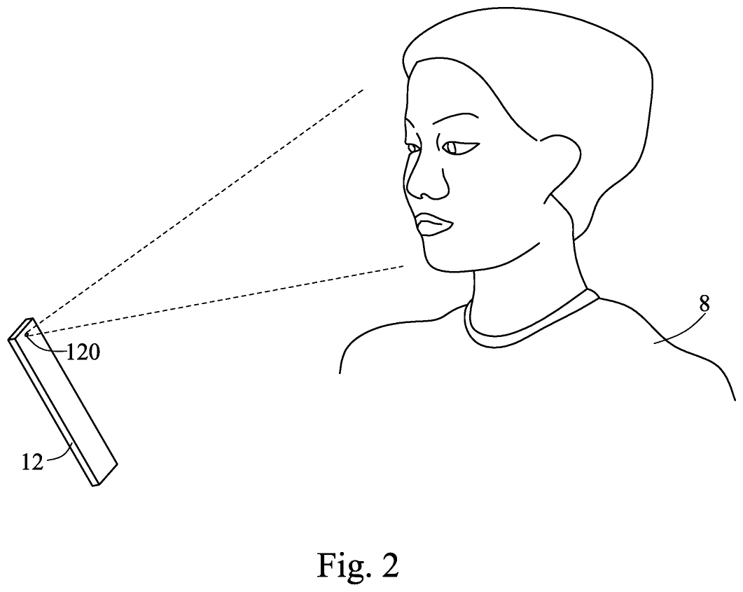

Again, with reference to FIG. 1 while referring to FIG. 2, FIG. 2 illustrates a view showing that the lens 120 scans a face of a user 8. The lens 120 and the display screen 124 are exposed outside the electronic device 12. In addition, the recognition unit 121 scans the face of the user 8 via the lens 120 to obtain a user feature information 121F. For example, in FIG. 2, the electronic device 12 takes a smart phone as an example to photograph the face of the user 8. Thus, the face may reveal the gender, hairstyle, skin color, age and appearance of the user 8. As such, the recognition unit 121 may form the user feature information 121F based on the above information (gender, hairstyle, skin color, age, and appearance).

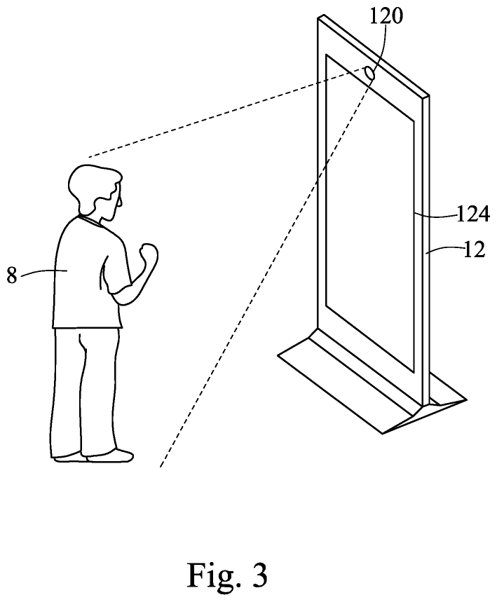

In above description, the recognition unit 121 obtains the user feature information 121F by scanning the face of the user 8. However, the recognition unit 121 may also obtain the user feature information 121F by scanning the whole body of the user 8 (please refer to FIG. 3, and FIG. 3 is a view showing that the lens scans the whole body of the user 8). For example, in FIG. 3, the electronic device 12 takes an upright advertising machine as an example to photograph the whole body of the user 8. Thus, the whole body may reveal the gender, hairstyle, skin color, age, height, body shape, appearance and wearing of the user 8. As such, the recognition unit 121 may form the user feature information 121F based on the above complete information (gender, hairstyle, skin color, age, height, body shape, appearance and wearing).

Still, with reference to FIG. 1, the online browsing unit 122 includes at least one online consumption behavior information 122C. In detail, the online consumption behavior information 122C is a website cookie that is temporarily stored on an online shopping platform after the user 8 purchases the product or service on the online shopping platform. In other words, the online consumption behavior information 122C is the consumption behavior performed by the user 8 on the online shopping platform. In the above description, for example, the online shopping platform is Tmall Shopping, eBay, Amazon, YAHOO, etc.

Further, the offline browsing unit 123 includes at least one offline consumption behavior information 123C. In detail, the offline consumption behavior information 122C is a consumption record of the user 8 on a physical store after purchasing the product or service in the physical store. In other words, the offline consumption behavior information 122C is the consumption behavior performed by the user 8 on the physical store. It should be noted that only a face recognition camera or an upright advertising machine is equipped may the physical store record the consumption behavior of the user 8. In the above description, for example, the physical store is Amazon Go.

In addition, the user feature information 121F, the online consumption behavior information 122C, and the offline consumption behavior information 123C are transmitted to the data management server 13 by the electronic device, and the data management server 13 includes an analysis unit 131. Among them, the analysis unit 131 generates a user preference information 131L according to the user feature information 121F, the online consumption behavior information 122C, and the offline consumption behavior information 123C, and the user preference information 131L is the purchasing preference and purchasing demand of the user 8.

Then, the advertising unit 132 may generate a multimedia file 132M according to the user preference information 131L, and the multimedia file 132M is an advertisement corresponding to the preferences and demands of the user 8, so the advertisement is extremely attractive to the user 8.

And then, the advertising unit 132 is further configured to transmit the multimedia file 132M to the electronic device 12, and the electronic device 12 plays the multimedia file 132M via the display screen 124. After the user 8 views the multimedia file 132M through the display screen 124, the user 8 is prone to generate a desire to purchase and a behavior of substantial consumption. Therefore, the advertising system 10 does increase the actual benefits of advertising.

In summary, through analysis and organization after summary and arrangement of multi-party data by using the data management platform (DMP), the present system may clearly depict a persona for the user of a brand, and then use it to deliver accurate receiver-oriented advertisements, so that the advertising effectiveness may be effectively improved.

The foregoing outlines features of several embodiments so that those skilled in the art may better understand the aspects of the present invention. Those skilled in the art should appreciate that they may readily use the present invention as a basis for designing or modifying other processes and structures for carrying out the same purposes and/or achieving the same advantages of the embodiments introduced herein. Those skilled in the art should also realize that such equivalent constructions do not depart from the spirit and scope of the present invention, and that they may make various changes, substitutions, and alterations herein without departing from the spirit and scope of the present invention.

What is claimed is:

1. An advertising system, characterized by comprising:
an electronic device including:
a lens exposed outside the electronic device;
an recognition unit scanning the face of a use or a body of the user through the lens to obtain a user feature information;
an online browsing unit including at least one online consumption behavior information; and
an offline browsing unit including at least one offline consumption behavior information; and
a data management server network connected to the electronic device, the user feature information, the online consumption behavior information, and the offline consumption behavior information being transmitted to the data management server, and the data management server including an analysis unit;
wherein the analysis unit generates a user preference information according to the user feature information, the online consumption behavior information, and the offline consumption behavior information.

2. The advertising system according to claim 1, characterized in that the data management server further includes an advertising unit, and the advertising unit generates a multimedia file according to the user preference information.

3. The advertising system according to claim 2, characterized in that the electronic device further includes a display screen, which is exposed outside the electronic device.

4. The advertising system according to claim 3, characterized in that the advertising unit is configured to transmit the multimedia file to the electronic device, and the electronic device plays the multimedia file via the display screen.

5. The advertising system according to claim 1, characterized in that the electronic device is a smart phone, a smart watch, a tablet, a laptop, or an upright advertising machine.
